(19) United States
(12) Patent Application Publication
(10) Pub. No.: US 2025/0206055 A1
(43) Pub. Date: Jun. 26, 2025

(54) LAYER FORMATION METHOD, SUBSTRATE REGENERATION METHOD, AND PRINTED MATTER PRODUCTION METHOD

(71) Applicant: BROTHER KOGYO KABUSHIKI KAISHA, Nagoya (JP)

(72) Inventor: Takefumi KAWAKAMI, Nagoya (JP)

(73) Assignee: BROTHER KOGYO KABUSHIKI KAISHA, Nagoya (JP)

(21) Appl. No.: 19/077,439

(22) Filed: Mar. 12, 2025

Related U.S. Application Data
(63) Continuation of application No. PCT/JP2023/030684, filed on Aug. 25, 2023.

(30) Foreign Application Priority Data
Sep. 13, 2022 (JP) 2022-145524

(51) Int. Cl. B41M 7/00; B41M 5/00

(52) U.S. Cl. CPC B41M 7/0009; B41M 5/0023; B41M 7/0081

(57) ABSTRACT

A layer formation method includes: an application step of applying or ejecting an aqueous composition containing an ultraviolet curing agent and water onto a substrate; and a drying step of drying the aqueous composition applied or ejected onto the substrate, in which a coating layer, which is peelable from the substrate, is formed on the substrate using the aqueous composition.

### REFERENCE TO RELATED APPLICATIONS

This is a continuation application of International Application No. PCT/JP2023/0 30684 filed on Aug. 25, 2023, which claims priority from Japanese Patent Application No. 2022-145524 filed on Sep. 13, 2022. The entire contents of the aforementioned applications are incorporated herein by reference.

### BACKGROUND ART

In recent years, recycling has been attracting attention due to growing environmental awareness. In the field of printing, there is a growing need to remove an ink from a package or the like of a product that has been subjected to printing after use of the product, and to recycle a substrate constituting the package. For example, a package using plastics or a plastic product such as a plastic bottle causes an environmental pollution issue in the oceans. For example, since the plastics are difficult to decompose in nature, some of them are classified, collected, and recycled. However, when a plastic product that has been subjected to printing or the like is mixed in during the recycling process, the recycled product may be discolored and may not be able to be reused. Such a plastic product that has been subjected to printing or the like is often discarded rather than reused. In the case where the discarded plastic product ends up in the oceans, the plastic product breaks down in seawater and becomes microplastics. When marine organisms such as fish ingest the microplastics, the microplastics are concentrated in the bodies of the marine organisms. At this time, there is concern that when humans ingest such marine organisms as food, it could have an adverse influence on human health. Such an issue is not limited to plastics, and may also be an issue with other substrates that have been subjected to printing.

From the viewpoint of recycling the substrates that have been subjected to printing or the like, methods for removing a printed matter from the substrates have been studied in the related art. For example, there has been disclosed a recording medium forming method that includes a step of forming, on a surface of a transparent recording medium, a removable film including an adhesive layer containing an ultraviolet-curable component and a substrate layer, and a step of forming an image on a surface of the substrate layer of the removable film. In the above recording medium forming method, in the case of reusing the transparent recording medium, an operator irradiates the removable film with ultraviolet light to cure the removable film, thereby decreasing an adhesion force of the removable film to the transparent recording medium, and removing the removable film from the transparent recording medium.

### SUMMARY

A layer formation method according to the present disclosure includes: an application step of applying or ejecting an aqueous composition containing an ultraviolet curing agent and water onto a substrate; and a drying step of drying the aqueous composition applied or ejected onto the substrate, in which a coating layer, which is peelable from the substrate, is formed on the substrate using the aqueous composition.

A substrate regeneration method according to the present disclosure includes an irradiation step of irradiating the coating layer formed by using the above layer formation method with ultraviolet light having a peak wavelength in a range of 200 nm to 400 nm.

A substrate regeneration method according to the present disclosure includes: an irradiation step of irradiating the coating layer formed by using the above layer formation method with ultraviolet light having a peak wavelength in a range of 350 nm to 400 nm.

A printed matter production method according to the present disclosure includes: an application step of applying or ejecting an aqueous composition containing an ultraviolet curing agent and water onto a substrate; and a drying step of drying the aqueous composition applied or ejected onto the substrate, in which a printing layer, which is peelable from the substrate, is formed on the substrate using the aqueous composition.

### BRIEF DESCRIPTION OF THE DRAWINGS

FIG. 1 is a simplified configuration diagram of an image recording apparatus 10 in which a layer formation method is to be used.

FIG. 2 is a schematic diagram of a coating layer 7 formed by using the layer formation method.

FIG. 3 is a diagram illustrating a state where adhesion between the coating layer 7 and a sheet 6 decreases when a printed matter 9 is irradiated with ultraviolet light by using a substrate regeneration method.

FIG. 4 is a schematic diagram of a coating layer 12 and a coloring material layer 11 formed by using a layer formation method.

### DESCRIPTION

Hereinafter, a preferred embodiment of the present disclosure will be described. Note that, the present embodiment is merely one embodiment of the present disclosure, and it is needless to say that the embodiment can be modified without changing the gist of the present disclosure.

### Internal Configuration of Image Recording Apparatus 10

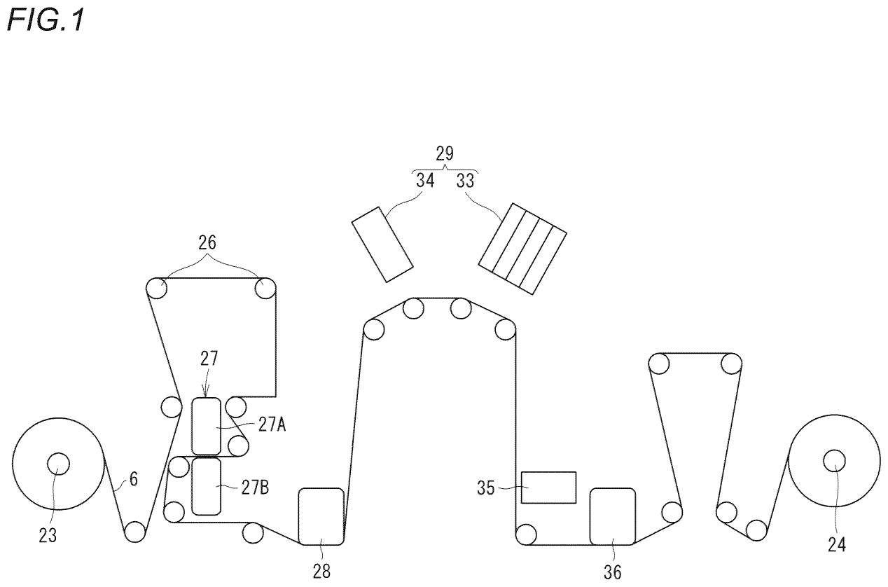

As shown in FIG. 1, an image recording apparatus 10 to be used in a layer formation method and a printed matter production method according to the present disclosure includes, in a housing (not shown), a supply roll 23, a plurality of conveying shafts 26, a web cleaner 27, a tension controller 28, a recording unit 29, a heater 35, a tension controller 36, and a rewinder 24. The image recording apparatus 10 records an image on a sheet 6.

The sheet 6 is an example of a substrate. The sheet 6 is a sheet cut to a predetermined dimension. The sheet 6 is a transparent non-permeable substrate. The non-permeable substrate is a substrate that has a surface having low water permeability. Specifically, the non-permeable substrate refers to a substrate having a water absorption amount of 10 mL/m² or less from the start of contact to 30 msec^{1/2} in a Bristow method. In addition, the “non-permeable or low-permeable” may refer to a water absorption rate of less than 0.5% in 24 hours measured in accordance with ASTM D570. More specifically, the “non-permeable” may refer to a water absorption rate of less than 0.2%, and the “low-permeable” may refer to a water absorption rate of 0.2% or more and less than 0.5%. Note that, the unit “%” of the water absorption rate is based on mass. Examples of a material of the transparent non-permeable substrate include plastics (for example, a polypropylene, a polyethylene, a polyethylene terephthalate, a polyvinyl chloride resin, and a polycarbonate). The transparent non-permeable substrate is suitably in the form of a film or a plate. Note that, the non-permeable substrate may not be transparent.

The sheet 6 may be a permeable substrate. In this case, the sheet 6 may be one drawn from a roll in which the sheet is wound in a cylindrical shape, or may be of a fanfold type. Examples of the permeable substrate include plain paper and coated paper. The “coated paper” refers to, for example, one obtained by applying a coating agent to plain paper made from pulp, such as high-grade printing paper or medium-grade printing paper to improve smoothness, whiteness, glossiness, and the like. Specific examples thereof include high-quality coated paper and medium-quality coated paper.

The supply roll 23 is located at a lower portion of the housing. The sheet 6 is wound around the supply roll 23. The supply roll 23 is rotated by a motor (not shown). The rotating supply roll 23 feeds the sheet 6 onto the plurality of conveying shafts 26.

The plurality of conveying shafts 26 are rotated by a motor (not shown). The plurality of rotating conveying shafts 26 convey the sheet 6 fed out from the supply roll 23.

The web cleaner 27 is located upstream of the recording unit 29 in a conveying direction of the sheet 6. The web cleaner 27 includes a rubber roller 27A and an adhesive roller 27B. The web cleaner 27 captures dust adhering to the sheet 6 with the rubber roller 27A and transfers the dust to the adhesive roller 27B, thereby cleaning the sheet 6.

The tension controller 28 is located upstream of the recording unit 29 in the conveying direction of the sheet 6. The tension controller 28 adjusts a tension applied to the sheet 6.

The recording unit 29 includes a printing head 34 (an example of an inkjet head) and a printing head 33. The printing head 34 is located downstream of the tension controller 28 in the conveying direction of the sheet 6. The printing head 34 may be a so-called serial head, or a so-called line head. The printing head 34 has a flow path therein through which an aqueous composition to be described later flows. The flow path is in communication with a tank through a tube. That is, the aqueous composition stored in the tank is supplied to the printing head 34 through the tube. The printing head 33 is located downstream of the printing head 34 in the conveying direction of the sheet 6. The printing head 33 includes inkjet heads for four colors: cyan, magenta, yellow, and black.

The heater 35 is located downstream of the printing head 33 in the conveying direction of the sheet 6. The heater 35 is a so-called halogen heater. The heater 35 includes a halogen lamp, which is a heating element that emits infrared light, a reflective plate, and a housing. Through openings in the housing, heat from the halogen lamp and the reflective plate is radiated to the outside or is blocked.

The heater 35 heats at least one of the sheet 6 passing near the heater 35 and the aqueous composition adhering to the sheet 6. In the present embodiment, the heater 35 heats both the sheet 6 and the aqueous composition. When the aqueous composition is heated, a resin component in the aqueous composition, to be described later, softens and forms a film on the sheet 6. Then, the sheet 6 and the resin component passing near the heater 35 are cooled, and thereby the resin component is solidified. Accordingly, the resin component is fixed to the sheet 6. Note that, the heater 35 is not limited to a halogen heater, as long as it is capable of heating the sheet 6 or the aqueous composition. For example, the heater 35 may be a carbon heater, a dryer, an oven, a belt conveyor oven, or the like.

The tension controller 36 is located downstream of the heater 35 in the conveying direction of the sheet 6. The tension controller 36 adjusts a tension applied to the sheet 6.

The rewinder 24 is located at the most downstream side of the conveying path. The rewinder 24 winds up the sheet 6 conveyed by the plurality of conveying shafts 26.

### Composition of Aqueous Composition

Hereinafter, details of the aqueous composition will be described. The aqueous composition contains an ultraviolet curing agent, a resin component, a coloring material, an organic solvent, a surfactant, and water. The aqueous composition is an aqueous ink in which an ultraviolet curing agent, a resin component, a coloring material, and an organic solvent are dissolved in water. The ultraviolet curing agent contains a photopolymerization initiator and a polymerizable compound.

The photopolymerization initiator is a water-soluble compound that causes a polymerization reaction of a polymerizable compound when irradiated with ultraviolet light. The photopolymerization initiator is in a state of being dissolved in water. The state where the photopolymerization initiator is dissolved in water refers to a state where 1 wt % or more of the photopolymerization initiator is dissolved in 100 g of water. Examples of the photopolymerization initiator include lithium phenyl-2,4,6-trimethylbenzoylphosphinate. Other examples of the photopolymerization initiator include 1-[4-(2-hydroxyethoxy)-phenyl]-2-hydroxy-2-methyl-1-propan-1-one, 2-hydroxy-2-methyl-1-phenyl-propan-1-one, a hydroxyalkylphenone-based initiator, an acetophenone-based initiator, a benzophenone-based initiator, a benzoin-based initiator, a benzoin ether-based initiator, an aminoalkylphenone-based initiator, a xanthone-based initiator, and an oxime-based initiator. Examples of the hydroxyalkylphenone-based initiator include 1-hydroxycyclohexyl phenyl ketone and 1-(4-isopropylphenyl)-2-hydroxy-2-methylpropan-1-one. Examples of the acetophenone-based initiator include acetophenone, 2,2-diethoxyacetophenone, and p-dimethylaminoacetophenone. Examples of the benzophenone-based initiator include benzophenone, 2-chlorobenzophenone, p,p′-dichlorobenzophenone, p,p′-bisdiethylaminobenzophenone, and Michler's ketone. Examples of the benzoin-based initiator and the benzoin ether-based initiator include benzoin, benzoin methyl ether, benzoin ethyl ether, benzoin isopropyl ether, benzoin n-propyl ether, benzoin isobutyl ether, and benzoin n-butyl ether. A solid content of the photopolymerization initiator in a total amount of ink is, for example, preferably in a range of 0.1 wt % or more and 10.0 wt % or less, more preferably in a range of 0.5 wt % or more and 5.0 wt % or less, and particularly preferably in a range of 0.8 wt % or more and 2.5 wt % or less.

The polymerizable compound is a water-soluble compound that undergoes a polymerization reaction due to a photopolymerization initiator when irradiated with ultraviolet light. The polymerizable compound is in a state of being dissolved in water. The state where the polymerizable compound is dissolved in water refers to a state where 1 wt % or more of the polymerizable compound is dissolved in 100 g of water. Examples of the polymerizable compound include N,N′-1,2-ethanediylbis {N-[2-(acryloylamino)ethyl] acrylamide}, N,N′-(((2-acrylamido-2 ((3-(buta-1,3-diene-2-ylamino) propoxy-1,3-diyl)bis(oxy))bis(propane-3,1-diyl))diacrylamide, N,N-bis(2-acrylamidoethyl) acrylamide, and N,N′-{oxybis(2,1-ethanediyloxy-3,1-propanediyl)} bisacrylamide. A solid content of the polymerizable compound in the total amount of ink is, for example, preferably in a range of 1.0 wt % or more and 40.0 wt % or less, more preferably in a range of 2.5 wt % or more and 40.0 wt % or less, and particularly preferably in a range of 5.0 wt % or more and 40 wt % or less.

As the resin component, for example, a commercially available product can be used. The resin component may contain, for example, styrene and vinyl chloride as a monomer. The resin component may be in a state of being dissolved in the aqueous composition or the aqueous composition may be in an emulsion state where the resin component is dispersed as resin particles. These resin components may be used alone or in combination of two or more kinds thereof. Examples of the resin component include an acrylic resin, a maleic acid-based ester resin, a vinyl acetate-based resin, a carbonate-based resin, a polycarbonate-based resin, a styrene-based resin, an ethylene-based resin, a polyethylene-based resin, a propylene-based resin, a polypropylene-based resin, a urethane-based resin, a polyurethane-based resin, a polyester-based resin, and a copolymer resin thereof.

As the resin component, a resin having a glass transition temperature (Tg) in a range of, for example, −30° C. or higher and 200° C. or lower is used. The glass transition temperature (Tg) is more preferably −30° C. or higher and 180° C. or lower, and still more preferably −30° C. or higher and 150° C. or lower.

As the emulsion, for example, a commercially available product may be used. Examples of the commercially available product include “SUPERFLEX (registered trademark) 870” (Tg: 71° C.) and “SUPERFLEX (registered trademark) 150” (Tg: 40° C.) manufactured by DKS Co., Ltd., “Mowinyl (registered trademark) 6760” (Tg:−28° C.) and “Mowinyl (registered trademark) DM774” (Tg: 33° C.) manufactured by Japan Coating Resin co., ltd., “POLYZOL (registered trademark) AP-3270N” (Tg: 27° C.) manufactured by Showa Denko Materials co., Ltd., and “HILOS-X (registered trademark) KE-1062” (Tg: 112° C.) and “HILOS-X (registered trademark) QE-1042” (Tg: 69° C.) manufactured by SEIKO PMC CORPORATION. “SUPERFLEX” is a registered trademark of DKS Co., Ltd. “Mowinyl” is a registered trademark of Japan Coating Resin co., ltd. “POLYZOL” is a registered trademark of Showa Denko Materials co., Ltd. “HILOS-X” is a registered trademark of SEIKO PMC CORPORATION.

The resin component has an average particle diameter, for example, in a range of 30 nm or more and 200 nm or less. The average particle diameter can be measured as an arithmetic mean diameter using, for example, a dynamic light scattering particle size distribution analyzer “LB-550” manufactured by Horiba, Ltd.

A content (R) of the resin component in the total amount of ink is, for example, preferably in a range of 0.1 wt % or more and 30 wt % or less, more preferably in a range of 0.5 wt % or more and 20 wt % or less, and particularly preferably in a range of 1.0 wt % or more and 15.0 wt % or less. The resin component may be used alone or in combination of two or more kinds thereof.

The coloring material is, for example, a pigment that can be dispersed in water by using a resin for pigment dispersion (a resin dispersant). Examples of the coloring material include carbon black, an inorganic pigment, and an organic pigment. Examples of the carbon black include furnace black, lamp black, acetylene black, and channel black. Examples of the inorganic pigment include titanium oxide, an iron oxide-based inorganic pigment, and a carbon black-based inorganic pigment. Examples of the organic pigment include: azo pigments such as azo lake, an insoluble azo pigment, a condensed azo pigment, and a chelate azo pigment; polycyclic pigments such as a phthalocyanine pigment, a perylene and perinone pigment, an anthraquinone pigment, a quinacridone pigment, a dioxazine pigment, a thioindigo pigment, an isoindolinone pigment, and a quinophthalone pigment; dye lake pigments such as a basic dye lake pigment and an acid dye lake pigment; nitro pigments; nitroso pigments; and aniline black daylight fluorescent pigments.

A solid content of the coloring material in the total amount of ink is not particularly limited, and can be appropriately determined depending on, for example, a desired optical density or chroma. The solid content of the coloring material is, for example, preferably in a range of 0.1 wt % or more and 20.0 wt % or less, and more preferably in a range of 1.0 wt % or more and 15.0 wt % or less. The solid content of the coloring material is the weight of the pigment alone, and does not include the weight of the resin component. The coloring material may be used alone or in combination of two or more kinds thereof.

The organic solvent is a solvent uniformly mixed with water when mixed in a ratio of 1:1. The organic solvent is not particularly limited, and any solvent can be used. Examples of the organic solvent include propylene glycol, ethylene glycol, 1,2-butanediol, propylene glycol propyl ether, dipropylene glycol propyl ether, diethylene glycol monobutyl ether, and 1,6-hexanediol. Propylene glycol or 1,2-butanediol is preferred. Examples of other organic solvents include: alkyl alcohols having 1 to 4 carbon atoms, such as methyl alcohol, ethyl alcohol, n-propyl alcohol, isopropyl alcohol, n-butyl alcohol, sec-butyl alcohol, and tert-butyl alcohol; alkylene glycols containing an alkylene group having 2 to 6 carbon atoms, such as ethylene glycol, propylene glycol, butylene glycol, triethylene glycol, 1,2,6-hexanetriol, thiodiglycol, hexylene glycol, and diethylene glycol; lower alkyl ethers of alkylene glycols such as glycerin, ethylene glycol monomethyl (or ethyl, propyl, butyl) ether, diethylene glycol monomethyl (or ethyl, propyl, butyl) ether, triethylene glycol monomethyl (or ethyl, propyl, butyl, hexyl) ether, tetraethylene glycol monomethyl (or ethyl, propyl, butyl, hexyl) ether, propylene glycol monomethyl (or ethyl, propyl, butyl) ether, dipropylene glycol monomethyl (or ethyl, propyl, butyl) ether, tripropylene glycol monomethyl (or ethyl, propyl, butyl) ether, and tetrapropylene glycol monomethyl (or ethyl) ether; N-methyl-2-pyrrolidone; 2-pyrrolidone; and 1,3-dimethyl-2-imidazolidinone.

A content of the organic solvent in the total amount of ink is, for example, preferably in a range of 1 wt % or more and 70 wt % or less, and more preferably in a range of 3 wt % or more and 50 wt % or less.

The water is preferably ion exchange water or pure water. A content of the water in the total amount of ink is, for example, preferably in a range of 15 wt % or more and 95 wt % or less, and more preferably in a range of 25 wt % or more and 85 wt % or less. The content of the water may be, for example, the balance except for other components.

The aqueous composition may further contain an additive known in the related art as necessary. Examples of the additive include a surfactant, a pH adjuster, a viscosity adjuster, a surface tension adjuster, a preservative, an antifungal agent, a leveling agent, an antifoaming agent, a light stabilizer, an antioxidant, a nozzle drying inhibitor, a polymer component such as an emulsion, and a dye. The surfactant may further include a nonionic surfactant. As the nonionic surfactant, for example, a commercially available product may be used. Examples of the commercially available product include “OLFINE (registered trademark) E1010”, “OLFINE (registered trademark) E1006”, and “OLFINE (registered trademark) E1004”, which are manufactured by Nissin Chemical co., ltd. “OLFINE” is a registered trademark of Nissin Chemical co., ltd. A content of the nonionic surfactant in the total amount of ink is, for example, 5 wt % or less, 3 wt % or less, or 0.1 wt % to 2 wt %. Examples of the viscosity adjuster include polyvinyl alcohol, cellulose, and a water-soluble resin.

The aqueous composition can be prepared by uniformly mixing, for example, the ultraviolet curing agent, the resin component, the coloring material, the organic solvent, the water, and other additives if necessary by using a method known in the related art, and removing insoluble matters using a filter or the like.

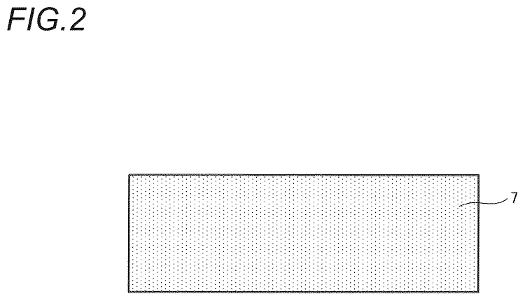

Next, the layer formation method and the printed matter production method using the image recording apparatus 10 will be described. In the layer formation method and the printed matter production method, an application step and a drying step are carried out in this order. Hereinafter, reference is made to FIG. 1 and FIG. 2.

In the application step, the aqueous composition is ejected onto the sheet 6. Specifically, in the application step, a printing step of ejecting the aqueous composition as droplets from the printing head 34 toward an upper surface 6a of the sheet 6 whose tension has been adjusted by the tension controller 28 is executed. Accordingly, a coating layer is formed on the upper surface 6a of the sheet 6. Note that, in the application step, the aqueous composition may be applied to the sheet 6.

After the application step, the drying step is executed. In the drying step, the aqueous composition ejected onto the sheet 6 is dried. Specifically, in the drying step, both the sheet 6 and the aqueous composition passing below openings in the heater 35 are dried by radiant heat from the heater 35. A drying temperature is in a range of 40° C. to 230° C. The drying temperature is more preferably in a range of 50° C. to 220° C. The drying temperature is particularly preferably in a range of 50° C. to 150° C. When the drying step is executed, the resin component in the aqueous composition forms a film, and then the sheet 6 and the resin component are cooled, to thereby solidify the resin component. As a result, as shown in FIG. 2, a coating layer 7 (an example of a printing layer) including a transparent clear layer made from the resin component and the coloring material is fixed on the upper surface 6a of the sheet 6. The coating layer 7 contains the ultraviolet curing agent. Note that, the drying step may be omitted. In FIG. 2, the sheet 6 is omitted for simplification of illustration.

Note that, in the present disclosure, the “printing” means reproducing characters, pictures, photographs, and the like by selectively applying or ejecting an ink. The “printing” includes not only so-called ink jet printing but also screen printing or the like. The “printing layer” refers to a layer formed by selectively applying or ejecting an ink.

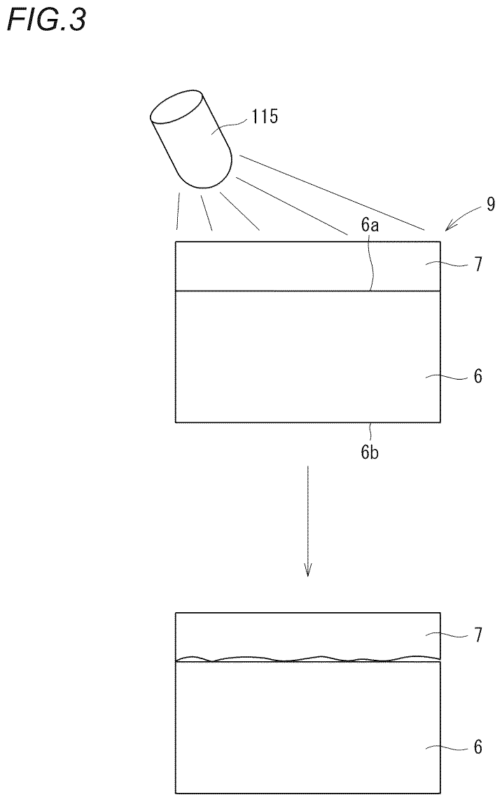

Next, a substrate regeneration method in which the coating layer 7 is peeled off from a printed matter 9 (see FIG. 3) produced by using the layer formation method and the printed matter production method will be described. The substrate regeneration method is carried out when recycling the sheet 6 after the printed matter 9 is produced by using the layer formation method and the printed matter production method. In the substrate regeneration method, an irradiation step is carried out.

In the irradiation step, the upper surface 6a (an example of a surface) of the sheet 6 on which the coating layer 7 is formed is irradiated with ultraviolet light. Note that, a lower surface 6b (an example of a back surface) of the sheet 6 opposite to the upper surface 6a may be irradiated with ultraviolet light. Accordingly, the coating layer 7 can be cured by using the ultraviolet curing agent present in the coating layer 7 while preventing the deterioration of the upper surface 6a of the sheet 6 on which the coating layer 7 is formed.

The ultraviolet light for irradiation onto the upper surface 6a of the sheet 6 has a peak wavelength in a range of 200 nm to 400 nm. The peak wavelength of the ultraviolet light is more preferably in a range of 300 nm to 400 nm. The peak wavelength of the ultraviolet light is particularly preferably in a range of 350 nm to 400 nm. As shown in FIG. 3, when the coating layer 7 is irradiated with ultraviolet light from a light source 115 in an ultraviolet irradiation device, the polymerizable compound undergoes a polymerization reaction due to the photopolymerization initiator in the ultraviolet curing agent contained in the coating layer 7. As a result, the coating layer 7 is cured, and thereby an adhesion force between the coating layer 7 and the sheet 6 decreases, and the coating layer 7 is easily peeled off from the sheet 6.

The ultraviolet irradiation device for emitting the ultraviolet light is not particularly limited as long as it can emit ultraviolet light having a specific wavelength. Examples of the ultraviolet irradiation device include one including a light source such as a metal halide lamp, a high pressure mercury lamp, an extra-high pressure mercury lamp, a deep ultraviolet lamp, an ultraviolet laser, a xenon lamp, and a UV-LED (ultraviolet light emitting diode). The ultraviolet irradiation device is preferably one including a UV-LED light source from the viewpoint of power consumption.

### Operation and Effect of Embodiment

In the layer formation method and the printed matter production method, since the ultraviolet curing agent is present in the coating layer 7 formed on the upper surface 6a of the sheet 6, an operator can irradiate the coating layer 7 with ultraviolet light to cure the coating layer 7. As a result, the adhesion force of the coating layer 7 to the sheet 6 decreases, and therefore, the operator can peel off the coating layer 7 from the sheet 6 and reuse the sheet 6. Since the peelable coating layer 7 is a coating layer 7 made from an aqueous composition, the risks to people and the environment can be reduced. Moreover, even in the case where the coating layer 7 is formed on the sheet 6 such as a plastic, adhesion between the coating layer 7 and the sheet 6 can be appropriately controlled, and excessive adhesion can be reduced. Therefore, in a recycling process after printing on the sheet 6 by using the layer formation method and the printed matter production method, the coating layer 7 can be easily peeled off from the sheet 6 by irradiating the coating layer 7 with ultraviolet light. Therefore, the sheet 6 can be easily reused. In addition, since a change in properties of the sheet 6 can be prevented, reusability of the sheet 6 after the coating layer 7 is peeled off from the sheet 6 can be improved. Therefore, printing can be performed on a wide variety of substrates, including plastics, and the recyclability after printing can be improved.

In the layer formation method and the printed matter production method, since the aqueous composition is ejected onto the sheet 6 by the printing head 34, the coating layer 7 can be easily formed on the sheet 6.

In the layer formation method and the printed matter production method, since a printing layer is formed by forming the coating layer 7 on the sheet 6, an extra coating layer can be reduced. In addition, since the coating layer can be formed locally, traces of the aqueous composition can be reduced.

In the layer formation method and the printed matter production method, since the drying step of drying the aqueous composition is carried out after the application step of ejecting the aqueous composition onto the sheet 6, the aqueous composition is easily fixed to the sheet 6. Therefore, the adhesion of the aqueous composition to the sheet 6 is high.

In the layer formation method and the printed matter production method, since the aqueous composition is an aqueous ink containing a coloring material, the application step plays a role of executing printing using the aqueous ink. Therefore, since an image is formed by forming the coating layer 7 on the sheet 6, the printing is easier than a case where a printing step of forming an image is carried out after steps including the application step and the drying step. During recycling, the aqueous composition is peeled off from the sheet 6 by irradiation with ultraviolet light, thereby playing a role of removing an aqueous ink from the substrate. Therefore, it is possible to provide a layer formation method that is environmentally friendly and that enables the substrate to be recycled while having a shortened printing time.

In the layer formation method and the printed matter production method, in the case where a printing step of ejecting or applying a printing ink onto the coating layer is executed after the application step, the aqueous composition plays a role of a base for printing using the printing ink in the printing step. During recycling, the aqueous composition is peeled off from the substrate together with a printing ink layer by irradiation with ultraviolet light, thereby playing a role of removing the printing ink layer from the substrate. Therefore, it is possible to provide a layer formation method that is environmentally friendly and that enables the substrate to be recycled.

In the layer formation method and the printed matter production method, since the photopolymerization initiator and the polymerizable compound are in a state of being dissolved in the water, the risks to people and the environment are reduced than a case of using an oil-based ultraviolet curing agent not soluble in water.

In the layer formation method and the printed matter production method, since the aqueous composition is in an emulsion state in which the resin component is dispersed in water, when the aqueous composition is dried in the drying step, the resin component is easily uniformly fixed to the sheet 6.

In the layer formation method and the printed matter production method, since the sheet 6 is a non-permeable substrate, when the application step is executed, the resin component in the aqueous composition is prevented from permeating the sheet 6. Therefore, in the recycling process for the printed matter produced by using the layer formation method and the printed matter production method, the coating layer 7 can be easily removed by irradiating the printed matter with ultraviolet light.

In the layer formation method and the printed matter production method, since the sheet 6 is a transparent substrate, when the application step is executed, the resin component in the aqueous composition is prevented from permeating the sheet 6. Therefore, in the recycling process for the printed matter produced by using the layer formation method and the printed matter production method, the coating layer 7 can be easily removed by irradiating the printed matter with ultraviolet light.

In the layer formation method and the printed matter production method, in the case where the aqueous composition ejected onto the sheet 6 in the application step is dried at a temperature in the range of 50° C. to 220° C. in the drying step, since the resin component forms a film and adheres to the sheet 6, the resin component has high adhesion to the sheet 6.

In the layer formation method and the printed matter production method, in the case where the aqueous composition ejected onto the sheet 6 in the application step is dried at a temperature in the range of 50° C. to 150° C. in the drying step, a film forming property of the resin component in the aqueous composition is improved, the adhesion to the substrate is appropriately controlled, and a curing performance of an ultraviolet curing component can be maintained in the drying step. Therefore, the adhesion of the coating layer 7 to the sheet 6 is high, and the coating layer 7 has high peelability during the recycling process after the printed matter is produced by using the layer formation method and the printed matter production method.

In the substrate regeneration method, in the irradiation step, since the printed matter 9 formed by using the layer formation method and the printed matter production method is irradiated with ultraviolet light having a peak wavelength in a range of 350 nm to 400 nm, the coating layer 7 on the upper surface 6a of the sheet 6 is cured by using the ultraviolet curing agent present in the coating layer 7. As a result, the adhesion force of the coating layer 7 to the sheet 6 decreases, and the coating layer 7 is easily peeled off from the sheet 6. Therefore, the sheet 6 can be easily recycled. In addition, since the ultraviolet light emitted onto the sheet 6 has a peak wavelength closer to visible light, damage to the sheet 6 is prevented. Compared to a known method of recycling the sheet 6 using a physical method or a chemical method, the damage to the sheet 6 during the recycling process can be prevented, and the number of times the sheet 6 can be regenerated can be increased.

In the substrate regeneration method, since the surface of the sheet 6 on which the coating layer 7 is formed is irradiated with ultraviolet light in the irradiation step, the coating layer 7 is easily cured by using the ultraviolet curing agent present in the coating layer 7. Therefore, the coating layer 7 has high peelability from the sheet 6.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modifications

In the layer formation method, in the application step, the printing step of ejecting the aqueous composition as droplets from the printing head 34 toward the upper surface 6a of the sheet 6 is executed. However, a printing step of ejecting a printing ink onto the coating layer may be further executed. In this case, the printing ink is ejected from the printing head 33 onto the coating layer, and the aqueous ink serves as a base for the printing using the printing ink. The printing ink is not particularly limited as long as an image can be formed on the coating layer.

In this case, the drying step may be executed after the first printing step or may be executed after the second printing step. Alternatively, the drying step may be executed both after the first printing step and after the second printing step. For example, in the case where the printing ink does not require a drying step, the drying step may be executed after the aqueous composition is applied or ejected, and then the printing step may be executed. On the other hand, in the case where the printing ink requires a drying step, the drying step may be executed after the execution of the printing step after the aqueous composition is applied or ejected, or the drying step may be executed after the aqueous composition is applied or ejected, then the printing step may be executed, and the drying step may be executed again.

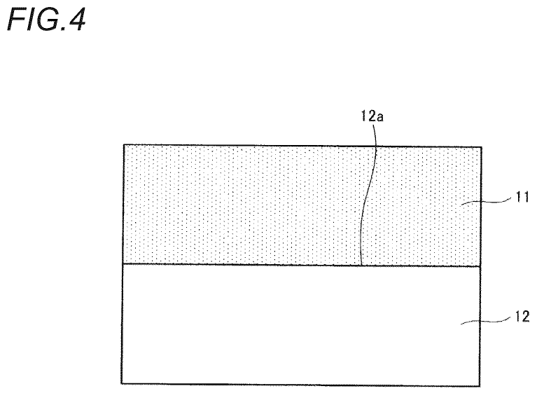

The aqueous composition contains a coloring material, but the coloring material may be omitted. In this case, a transparent coating layer made from a resin component is formed on the sheet 6 in the application step. After the application step, a printing step of ejecting the printing ink onto the coating layer may be executed. The aqueous composition plays a role of a base for the printing using the printing ink. When the printing step is executed, as shown in FIG. 4, a coloring material layer 11 made from a coloring material contained in the printing ink is formed on an upper surface 12a of a transparent coating layer 12 free of the coloring material. In this case, a printing layer is formed by the coating layer 12 and the coloring material layer 11. Note that, in FIG. 4, the sheet 6 is omitted for simplification of illustration.

### EXAMPLES

Hereinafter, Examples of the present disclosure will be described.

### Example 1

The aqueous composition used was one containing 1.0 wt % of lithium phenyl-2,4,6-trimethylbenzoylphosphinate as a photopolymerization initiator, 5.0 wt % of N,N′-1,2-ethanediylbis {N-[2-(acryloylamino)ethyl] acrylamide} as a polymerizable compound, 5.0 wt % of Mowinyl 6760 as a resin component, 10.0 wt % of propylene glycol as an organic solvent, and ion exchange water as a solvent, being the balance. The drying temperature in the drying step was set to 90° C. In the irradiation step, irradiation with ultraviolet light was carried out.

### Example 2

It is different from Example 1 in that the aqueous composition further contains 5.0 wt % of a carbon black pigment dispersion liquid as a coloring material and 0.5 wt % of OLFINE E1010 as a surfactant. Other conditions are the same as those in Example 1. Note that, the carbon black pigment dispersion liquid was prepared as follows. First, 40 g of carbon black “#2650” manufactured by Mitsubishi Chemical Corporation was mixed with 200 g of ion exchange water, followed by pulverization in a bead mill. A carboxy group agent was added thereto, followed by heating and stirring, and an oxidation treatment was carried out. Next, the obtained liquid was washed several times with a solvent, poured into water, washed again with water, and then filtered through a filter to obtain a carbon black pigment dispersion liquid.

### Example 3

It is different from Example 1 in that a black ink (LC3139 manufactured by Brother Industries, Ltd.) is used. In Example 3, after the application step of applying the aqueous composition onto a sheet (substrate), a printing step of applying a black ink as a printing ink onto the coating layer was executed. Note that, the aqueous composition used was the same as that in Example 1.

### Example 4

It is different from Example 1 in that the drying temperature in the drying step was set to 50° C. Other conditions are the same as those in Example 1.

### Example 5

It is different from Example 4 in that the drying temperature in the drying step was set to 60° C. Other conditions are the same as those in Example 4.

### Example 6

It is different from Example 4 in that the drying temperature in the drying step was set to 120° C. Other conditions are the same as those in Example 4.

### Example 7

It is different from Example 4 in that the drying temperature in the drying step was set to 150° C. Other conditions are the same as those in Example 4.

### Comparative Example 1

It is the same as Example 1, except that the irradiation step was not carried out.

### Comparative Example 2

It is different from Comparative Example 1 in that the aqueous composition further contains 5.0 wt % of carbon black as the coloring material and that the aqueous composition further contains 0.5 wt % of OLFINE E1010 as the surfactant. The balance is ion exchange water. Other conditions are the same as those in Comparative Example 1.

### Comparative Example 3

It is different from Example 1 in that plain paper for printing (Multi-paper Super White+manufactured by ASKUL Corporation) was used as the sheet 6. Other conditions are the same as those in Example 1.

### Layer Formation Method

Hereinafter, the coating layer formed on the sheet using the aqueous composition was tested for fixability and peelability.

### Fixability Test

In the application step, the aqueous composition was dropped onto the upper surface of the sheet using a dropper in an amount of 50 mg/cm², and in the drying step, the aqueous composition on the upper surface of the sheet was dried at a predetermined drying temperature for 3 hours, to form a coating layer made from the aqueous composition on the upper surface of the sheet. A fixability test was carried out, in which an adhesive tape was attached to the surface of the coating layer on the sheet and the adhesive tape was peeled off from the coating layer. In Examples 1 to 7 and Comparative Examples 1 and 2, the sheet used was a PET film. In Comparative Example 3, the sheet used was plain paper for printing (Multi-paper Super White+manufactured by ASKUL Corporation). The adhesive tape used was a cellophane tape [Cellulose Tape (registered trademark) CT-12 (manufactured by NICHIBAN Co., Ltd.)]. “Cellulose Tape” is a registered trademark of NICHIBAN Co., Ltd. The fixability of the coating layer to the sheet was evaluated according to the following evaluation criteria.
A: did not peel off
B: peeled off

### Peelability Test

In the irradiation step, the sheet was irradiated with ultraviolet light for 10 seconds from an ultraviolet irradiation device at a distance of 100 mm. The ultraviolet irradiation device used was a UV-LED light [printing UV-LED series E075Z HC (manufactured by Ushio Inc.), 395 nm]. Thereafter, a peel test was carried out under the following two conditions.

Condition 1: An adhesive tape was attached to the surface of the sheet and the coating layer after the irradiation with ultraviolet light, and the adhesive tape was peeled off from the coating layer.

Condition 2: The sheet and the coating layer after the irradiation with ultraviolet light were folded in half and then returned to the original state, then an adhesive tape was attached to the surface of the sheet and the coating layer, and the adhesive tape was peeled off from the coating layer. Note that, when the sheet and the coating layer were folded in half under the condition 2, cracks are generated in the coating layer, and thus the peelability can be improved. The adhesive tape used was a cellophane tape [Cellulose Tape (registered trademark) CT-12 (manufactured by NICHIBAN Co., Ltd)]. The peelability of the coating layer to the sheet was evaluated according to the following evaluation criteria.
A: peeled off under both the condition 1 and the condition 2
B: did not peel off under the condition 1, but peeled off under the condition 2
C: did not peel off under either the condition 1 or the condition 2

TABLE 1

| | | | | | | | | Com- | Com- | Com- |
|---|---|---|---|---|---|---|---|---|---|---|
| | | | | | | | | parative | parative | parative |
| | Example | Example | Example | Example | Example | Example | Example | Example | Example | Example |
| | 1 | 2 | 3 | 4 | 5 | 6 | 7 | 1 | 2 | 3 |
| Photopolymeri- | 1 | 1 | 1 | 1 | 1 | 1 | 1 | 1 | 1 | 1 |
| zation initiator | | | | | | | | | | |
| (wt %) | | | | | | | | | | |
| Polymerizable | 5 | 5 | 5 | 5 | 5 | 5 | 5 | 5 | 5 | 5 |
| compound | | | | | | | | | | |
| (wt %) | | | | | | | | | | |
| Resin | 5 | 5 | 5 | 5 | 5 | 5 | 5 | 5 | 5 | 5 |
| component | | | | | | | | | | |
| (wt %) | | | | | | | | | | |
| Coloring | | 5 | | | | | | | 5 | |
| material | | | | | | | | | | |
| (wt %) | | | | | | | | | | |
| Organic | 10 | 10 | 10 | 10 | 10 | 10 | 10 | 10 | 10 | 10 |
| solvent | | | | | | | | | | |
| (wt %) | | | | | | | | | | |
| Surfactant | | 0.5 | | | | | | | 0.5 | |
| (wt %) | | | | | | | | | | |
| Solvent | Balance | Balance | Balance | Balance | Balance | Balance | Balance | Balance | Balance | Balance |
| Black ink | | | Drop | | | | | | | |
| Drying | 90 | 90 | 90 | 50 | 60 | 120 | 150 | 90 | 90 | 90 |
| temperature | | | | | | | | | | |
| (° C.) | | | | | | | | | | |
| Sheet | PET | PET | PET | PET | PET | PET | PET | PET | PET | Plain |
| | | | | | | | | | | paper |
| UV irradiation | Yes | Yes | Yes | Yes | Yes | Yes | Yes | No | No | Yes |
| Fixability | A | A | A | B | A | A | A | A | A | A |
| Peelability | A | A | A | A | A | A | A | C | C | C |

### Fixability Test Evaluation

As shown in Table 1, in all of Examples 1 to 3, Examples 5 to 7, and Comparative Examples 1 to 3, no peeling occurred and therefore the evaluation was A. This is thought to be because the drying temperature in the drying step was 90° C. or higher, so that the film formation of the resin component in the aqueous composition proceeded sufficiently and the adhesion to the upper surface of the sheet was improved.

In Example 4, peeling occurred and therefore the evaluation was B. This is thought to be because the drying temperature in Example 4 was 50° C., which is lower than the other Examples and Comparative Examples 1 and 2, so that the film forming property of the resin component and the adhesion of the resin component to the upper surface of the sheet was lower than those in Examples 1 to 3 and 5 to 7 and Comparative Examples 1 and 2.

### Peelability Test Evaluation

As shown in Table 1, in all of Examples 1 to 7, peeling occurred under both the condition 1 and the condition 2, and therefore the evaluation was A. This is thought to be because in the irradiation step, the upper surface of the sheet on which the coating layer was formed was irradiated with ultraviolet light, and as a result, the polymerization reaction of the polymerizable compound in the film was accelerated by the photopolymerization initiator to cure the layer, so that the adhesion force of the coating layer to the sheet sufficiently decreased.

In contrast, in all of Comparative Examples 1 and 2, no peeling occurred under either the condition 1 or the condition 2, and therefore the evaluation was C. This is thought to be because, in the irradiation step, the coating layer on the upper surface of the sheet was not irradiated with ultraviolet light, so that the polymerization reaction of the polymerizable compound in the layer did not proceed at all, and the adhesion force of the coating layer to the sheet did not decrease.

In Comparative Example 3, no peeling occurred under either the condition 1 or the condition 2, and therefore the evaluation was C. This is thought to be because the sheet was a plain paper for printing as a permeable substrate, so that the aqueous composition permeated the sheet.

As seen from the above, in the case where the drying temperature in the drying step is set in the range of 60° C. to 150° C., and the coating layer on the upper surface of the sheet is irradiated with ultraviolet light in the irradiation step, the evaluation for the fixability is A and the evaluation for the peelability is A. In addition, since a drying temperature in the range of 50° C. to 150° C. is a sufficient drying temperature from the viewpoint of fixability, a coating film is formed and the adhesion can be ensured, and in recycling, the coating layer can be easily peeled off from the sheet by irradiating the coating layer with UV light, allowing the sheet to be recycled.

What is claimed is:

1. A layer formation method comprising:
an application step of applying or ejecting an aqueous composition containing an ultraviolet curing agent and water onto a substrate; and
a drying step of drying the aqueous composition applied or ejected onto the substrate, wherein
a coating layer, which is peelable from the substrate, is formed on the substrate using the aqueous composition.

2. The layer formation method according to claim 1, wherein in the application step, the aqueous composition is ejected onto the substrate by an inkjet head.

3. The layer formation method according to claim 1, wherein the coating layer is a printing layer.

4. The layer formation method according to claim 1, wherein
the aqueous composition is an aqueous ink containing a coloring material, and the application step is a printing step of applying or ejecting the aqueous ink onto the substrate.

5. The layer formation method according to claim 1, further comprising:
a printing step of ejecting or applying a printing ink onto the coating layer obtained by application or ejection onto the substrate, wherein
the drying step is executed after the printing step or between the application step and the printing step.

6. The layer formation method according to claim 1, wherein the drying step is a step of drying the aqueous composition applied or ejected onto the substrate in the application step at a temperature in a range of 50° C. to 220° C.

7. The layer formation method according to claim 1, wherein the drying step is a step of drying the aqueous composition applied or ejected onto the substrate in the application step at a temperature in a range of 50° C. to 150° C.

8. The layer formation method according to claim 1, wherein the aqueous composition contains a photopolymerization initiator and a polymerizable compound as the ultraviolet curing agent, and the photopolymerization initiator and the polymerizable compound are in a state of being dissolved in the water.

9. The layer formation method according to claim 1, wherein the aqueous composition contains a resin component for forming the coating layer, and is in an emulsion state where the resin component is dispersed in the water.

10. The layer formation method according to claim 9, wherein the substrate is a non-permeable substrate.

11. The layer formation method according to claim 10, wherein the substrate is a transparent substrate.

12. A substrate regeneration method comprising:
an irradiation step of irradiating the coating layer formed by using the layer formation method according to claim 1 with ultraviolet light having a peak wavelength in a range of 200 nm to 400 nm.

13. A substrate regeneration method comprising:
an irradiation step of irradiating the coating layer formed by using the layer formation method according to claim 1 with ultraviolet light having a peak wavelength in a range of 350 nm to 400 nm.

14. The substrate regeneration method according to claim 12, wherein the irradiation step is a step of irradiating, with the ultraviolet light, a surface of the substrate on which the coating layer is formed.

15. The substrate regeneration method according to claim 12, wherein in the irradiation step, a back surface of the substrate opposite to a surface of the substrate on which the coating layer is formed is irradiated with the ultraviolet light.

16. A printed matter production method comprising:
an application step of applying or ejecting an aqueous composition containing an ultraviolet curing agent and water onto a substrate; and
a drying step of drying the aqueous composition applied or ejected onto the substrate, wherein
a printing layer, which is peelable from the substrate, is formed on the substrate using the aqueous composition.

17. The printed matter production method according to claim 16, wherein the aqueous composition contains a photopolymerization initiator and a polymerizable compound as the ultraviolet curing agent, and the photopolymerization initiator and the polymerizable compound are in a state of being dissolved in the water.

18. The printed matter production method according to claim 17, wherein the aqueous composition contains a resin component, and is in an emulsion state where the resin component is dispersed in the water.

19. The printed matter production method according to claim 16, wherein the substrate is a transparent non-permeable substrate.
